(19) United States
(12) Patent Application Publication
(10) Pub. No.: US 2026/0302974 A1
(43) Pub. Date: Oct. 1, 2026

(54) SYSTEM HAVING A DRIVE AND A SMARTPHONE

(71) Applicant: SEW-EURODRIVE GMBH & CO. KG, Bruchsal (DE)

(72) Inventors: Rogério Goncalves DONHA, Indaiatuba-SP (BR); Lucas da Silva MORAES, Indaiatuba-SP (BR)

(73) Assignee: SEW-EURODRIVE GMBH & CO. KG, Bruchsal (DE)

(21) Appl. No.: 19/489,428

(22) PCT Filed: May 7, 2024
(86) PCT No.: PCT/EP2024/062627

§ 371 Date: Dec. 2, 2025

(30) Foreign Application Priority Data
Jun. 2, 2023 (DE) 10 2023 002 248.9

(51) Int. Cl. H02P 6/10; H02P 23/00; H04M 3/22

(52) U.S. Cl. CPC H02P 6/10; H02P 23/0018; H04M 3/22

(57) ABSTRACT

A system includes a drive which has a transmission driven by an electric motor, a supporting device having a permanent magnet, and a smartphone. The smartphone has a vibration sensor, a data collection device, a signal transformation device, and an evaluation unit. The smartphone is configured to supply the data collection device with values recorded by the vibration sensor, store a temporal profile of the values in the data collection device as a value profile, transform the value profile using the signal transformation device, and evaluate the transformed value profile using the evaluation unit and compare it with transformed value profiles previously stored in the smartphone and display and/or dispatch and/or send a warning in the event of an excessive deviation of the transformed value profile from the stored transformed value profiles.

### FIELD OF THE INVENTION

The present invention relates to a system having a drive and a smartphone.

### BACKGROUND INFORMATION

In certain conventional systems, a smartphone is arranged as a mobile and/or portable communication device whose largest extension is less than 17 cm and whose mass is less than 200 grams, and the smartphone is operable as a participant in a wireless local network, in particular, for exchanging data with another participant in the local network.

A smartphone sensor-based condition monitoring measurement method is described in Korean Patent Document No. 10-2002-0077004.

A machine monitor is described in U.S. Pat. No. 6,297,742.

An error analysis method is described in U.S. Patent Application Publication No. 2021/0247269.

A method for calibrating a control device of an electric motor is described in Austrian Patent Document No. 523109.

A method for operating a drive is described in German Patent Document No. 10 2010 051 864.

### SUMMARY

Example embodiments of the present invention provide a ready and cost-effective analysis of a drive.

According to example embodiments, a system includes a drive, e. g., a transmission motor fed by a converter, which has a transmission driven by an electric motor, a supporting device having a permanent magnet, and a smartphone. The smartphone includes a vibration sensor, e. g., a structure-borne sound sensor, a data collection device, a signal transformation device, and an evaluation unit. The smartphone is configured to supply the data collection device with values recorded by the vibration sensor, store a temporal profile of the values in the data collection device as a value profile, transform the value profile using the signal transformation device, and evaluate the transformed value profile using the evaluation unit and compare it with transformed value profiles previously stored in the smartphone and display and/or dispatch and/or send a warning in the event of an excessive deviation of the transformed value profile from the stored transformed value profiles.

An advantage of this is that the drive can be analyzed using a smartphone. This is because the smartphone has a vibration sensor and is thus able to detect the structure-borne noise emitted by a drive. In this manner, it is possible to detect structure-borne sound in a ready and cost-effective manner. This also includes vibrations caused by imbalance.

A deviating behavior can be identified by comparison with value profiles captured in a normal condition. A neural network of the evaluation unit is particularly well suited for this purpose, which first receives the value profiles corresponding to the normal condition in a learning phase and then evaluates the currently received transformed value profile.

According to example embodiments, the evaluation unit has a neural network for comparing, to which the stored transformed value profiles were fed in a learning phase, for example. An advantage of this is that a comparison can be carried out quickly and readily.

According to example embodiments, the signal transformation is a Laplace transformation or a Fourier transformation. An advantage of this is that the effects originating from periodic excitations are clearly recognizable, e.g., in a spectrum. For example, the excessive amplitude in the spectrum at a first frequency can be recognized quickly, readily, and clearly.

According to example embodiments, the drive has a ferromagnetic part, e.g., the bearing flange of the transmission, and the supporting device having the permanent magnet is magnetically fastened to the ferromagnetic part. The supporting device has a flat surface on its side facing the smartphone, on which surface a smartphone is placed, e.g., the holding device prevents the smartphone from slipping parallel to the plane of the flat surface. For example, the holding device includes an elastically deformable band, e.g., which wraps around the smartphone and the drive, or the holding device has a material, e.g., plastic, e.g., plasticine, which adheres to the housing of the transmission. An advantage of this is that the supporting device provides a flat surface and thus provides for efficient coupling of the smartphone to the drive. By the magnetically attracting force, the smartphone is pressed against the supporting device without play and thus is sufficiently well coupled for structure-borne sound.

According to example embodiments, the supporting device is fastened to the drive by a screw, which is screwed into a threaded bore of the drive, e.g., of the ferromagnetic part, and is formed as a holder for the smartphone, and the holder is pressed against the ferromagnetic part by the screw. An advantage of this is that a ready, cost-effective, and stable fastening provides for sufficiently good coupling.

According to example embodiments, the supporting device is fastened to the drive and formed as a holder for the smartphone by a threaded bolt connected to a holder by a material-bonding connection, which threaded bolt is screwed into a threaded bore of the drive, e.g., of the ferromagnetic part. An advantage of this is that it provides for ready, cost-effective, and secure coupling and stable fastening.

According to example embodiments, the converter has a superordinate control which is suitably configured such that the superordinate control regulates the amplitude of a first frequency of the vibration recorded by the vibration sensor to zero, in that the superordinate control sets the phase and amplitude of a torque ripple, which are transmitted to a control device for controlling the torque of the electric motor of the drive, and the torque ripple is added to a torque target value of the control device. An advantage of this is that once an excessive amplitude has been detected at the first frequency, active attenuation can be introduced at this frequency. This is because a sinusoidal torque ripple, which has the first frequency and whose phase and amplitude are set by a control device such that the amplitude of the first frequency of the vibration is minimized, is added to the target value of the torque controller of the converter. As soon as this minimum is found, the torque ripple found in this manner is stored as a function of the angular position of the rotor shaft of the electric motor and permanently added to the torque target value, even during normal operation. This thus reduces the amplitude of the first frequency of the vibration.

According to example embodiments, the electric motor has an angle sensor for determining the angular position, e.g., the absolute angular position, of the rotor of the electric motor and the drive is arranged such that the torque ripple determined as a function of the angular position, which torque ripple has the amplitude and phase at which the amplitude of the first frequency of the vibration does not exceed a permissible level, is permanently added to the torque target value during normal operation, e.g., when the smartphone is removed from the supporting device. An advantage of this is that the amplitude and phase values found by the control for minimizing the amplitude at the first frequency define a torque ripple that can be permanently added to the torque target value as a function of the angular position of the rotor shaft.

According to example embodiments, in a method of operating a system, in a first method step, the values recorded by the sensor are stored as a value profile, in a second method step following the first in time, the value profile is transformed, and, in a third method step following the second method step in time, the value profile is checked by a neural network for exceedance of a permissible degree of deviation, e.g., in which permissible transformed value profiles are fed to the neural network in a learning phase carried out before the first method step.

An advantage of this is that the method can be carried out using a smartphone and is thus inexpensive.

According to example embodiments, in a fourth method step following the third step in time, the amplitude of a first frequency of the vibration recorded by the vibration sensor is regulated to zero, in that the superordinate control sets the phase and amplitude of a torque ripple which are transmitted to a control device for controlling the torque of the electric motor of the drive, and the torque ripple is added to a torque target value of the control device. An advantage of this is that the excessive amplitude of the first frequency can be reduced by the control device finding the optimum torque ripple and then permanently adding this torque ripple to the torque target value as an angle-dependent function, i.e., even after removing the smartphone.

According to example embodiments, the angular position, e.g., the absolute angular position, of the rotor of the electric motor is determined and the phase and the amplitude at which the smallest amplitude of the first frequency is reached are used to determine a torque ripple which has the first frequency, e.g., is sinusoidal, and is determined as a function of the angular position and which is added to the torque target value, e.g., taking into account the angular dependence. For example, the amplitude of the first frequency of the vibration does not exceed a permissible level, e.g., during normal operation, i.e., for example, when the smartphone is removed from the supporting device. An advantage of this is that the optimum torque ripple is determined as a function of the angular position of the rotor shaft and can thus be taken into account in continuous operation. For example, the electric motor is a synchronous motor, e.g., because for this motor the torque ripple can be specified with high precision as a function of the angular position of its rotor shaft.

Further features and aspects of example embodiments of the present invention are explained in more detail below with reference to the appended schematic Figures.

### BRIEF DESCRIPTION OF THE DRAWINGS

FIG. 1 illustrates a system having a drive.

FIG. 2 illustrates a system with a drive arranged as an electric motor.

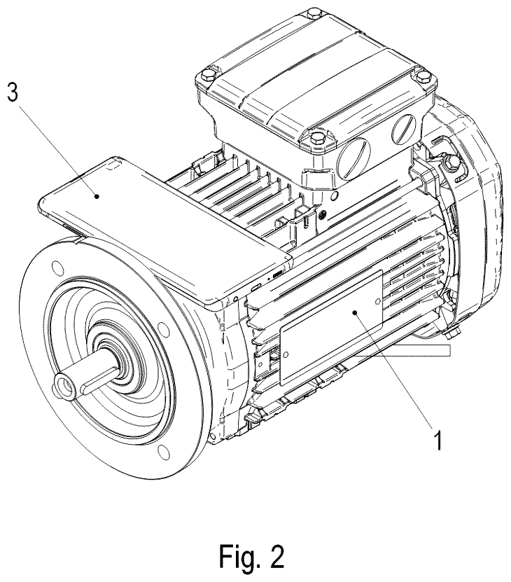

FIG. 3 illustrates shows a holder 30 for a system with a threaded bolt 31 connected by a material-bonding connection.

### DETAILED DESCRIPTION

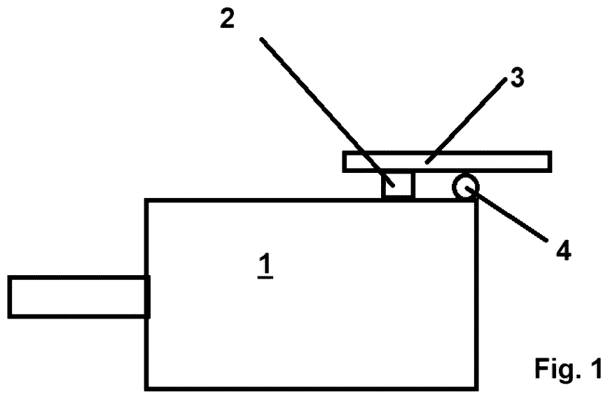

As illustrated in FIG. 1, the system has a drive, e. g., a transmission motor, in which a supporting device 2 is attached to a ferromagnetic part of the drive, for example, a bearing flange, which supporting device 2 includes a permanent magnet and is thus held magnetically on the ferromagnetic part of the drive.

The supporting device 2 has a flat surface on its side facing away from the drive, on which surface a smartphone 3 is placed.

A holding device 4 prevents the smartphone from slipping parallel to the plane of the flat surface, e.g., from slipping sideways relative to the supporting device 2.

The holding device 4 may be arranged as an elastically deformable band that wraps around the smartphone 3 and the drive, or the holding device 4 includes a material that adheres to the housing of the transmission, e.g., plastic, e.g., plasticine.

The smartphone 3 has a sensor for acquiring vibration, e.g., structure-borne sound. In addition, a data collection device is arranged in the smartphone 3, in which data collection device the values recorded by the sensor are stored.

Thus, after capturing the temporal profile of the vibration values, e.g., the structure-borne sound, the captured data can be analyzed.

For this purpose, the smartphone 3 has a signal transformation device, e.g., a Fourier transformation device.

For example, the captured signal profile is transformed, e.g., Fourier transformed, e.g., by an FFT, e.g., Fast Fourier Transformation.

The transformed value profile is fed to an evaluation unit, which compares the transformed value profile with previously stored transformed value profiles and issues a warning message on the smartphone 3 if there is an excessive deviation. For example, the evaluation unit has a neural network to which permissible value profiles are supplied during a learning phase, so that, during operation started after the learning phase, the evaluation unit detects value profiles that deviate excessively. For example, an imbalance can be seen on one of the rotatably mounted shafts of the transmission motor.

For example, the smartphone 3 has a ferromagnetic part so that the smartphone 3 is held magnetically by the permanent magnet.

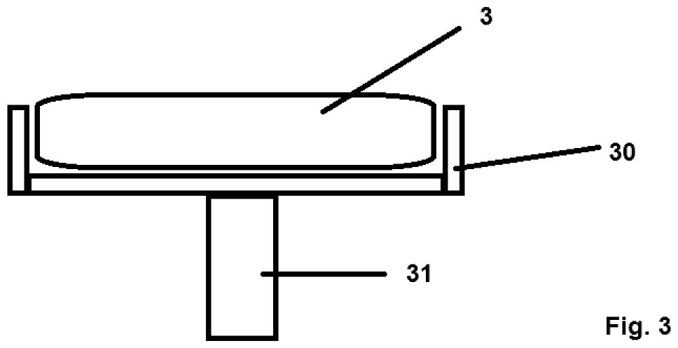

According to example embodiments, the smartphone 3 is placed in a holder 30, which is pressed against a flat surface region by a screw that is screwed into a threaded bore introduced into the ferromagnetic part, e. g., the end shield, e.g., by the screw head of the screw. The screw head has a permanent magnet, e.g., so that the smartphone 3 rests as directly as possible against the screw head. The holder prevents the smartphone from slipping sideways 3. Alternatively, as illustrated in FIG. 3, instead of the screw, a threaded bolt 31 is arranged with the holder as a composite part, e.g., connected to the holder by a material-bonding connection. The threaded bolt is screwed into the threaded bore introduced into the ferromagnetic part, e.g., the end shield. In this manner, a particularly good coupling can be achieved. For example, a permanent magnet can also be arranged in the holder so that the smartphone 3 is additionally magnetically attracted if it has a ferromagnetic part or a permanent magnet.

The evaluation unit, the signal transformation device and the data collection device are arranged within the signal electronics of the smartphone 3 and are, for example, arranged in one component, e.g., an IC.

According to example embodiments, a Laplace transform is performed instead of the Fourier transform.

According to example embodiments, the electric motor has an angle sensor which records the absolute angular position of the rotor shaft of the electric motor and feeds it to the signal electronics of a converter which feeds the electric motor. The signal electronics has a control device to which a torque target value and also the motor current recorded at the electric motor is specified.

The converter has a rectifier which provides a unipolar intermediate circuit voltage to the inverter of the converter, and the electric motor is supplied from the AC-side connection of the inverter. The intermediate circuit voltage is also recorded by a sensor and fed to the control device.

An actual value, e.g., a model value, of the torque of the electric motor is determined from the recorded variables, e.g., the motor current and intermediate circuit voltage. The control device determines a motor voltage as a control variable, and the motor voltage is provided by the inverter supplied from the intermediate circuit voltage by operating its power semiconductor switches in a pulse-width modulated manner.

The actual value of the torque is adjusted to the torque target value by the control device in that the control device sets the pulse width modulation ratio for the power semiconductor switches.

For example in a problem case, at least a first frequency of the spectrum with an excessive amplitude can be recognized from the value profile determined by the smartphone 3. This is caused, for example, by bearing damage or wear on a tooth of the toothing of a toothing part of the transmission. However, if the excessive amplitude is caused by a geometric deviation of the tooth shape or the tooth spacing, there is an increased amplitude, but no direct damage.

As described herein, a sinusoidal torque ripple is added to the specified torque target value by appropriately specifying the temporal profile of the pulse width modulation ratio, so that the control device regulates the actual value of the torque to this rippled torque target value. The first frequency is specified as the frequency of the torque ripple. The amplitude and phase of the torque ripple is set by a superordinate control system such that the excessive amplitude is regulated to zero or at least pushed into the permissible range. In this manner, a reduction in structure-borne noise emissions can be achieved.

The above-mentioned torque ripple thus acts as a component of the target value for torque that runs periodically over time. The total target value for torque is thus the sum of the torque target value and the torque ripple, and the torque ripple changes faster over time in relation to the torque target value. For example, the torque target value is constant over time.

The smartphone 3 is wirelessly connected to the signal electronics of the converter, e.g., by a radio wave transmission and/or Bluetooth, WLAN or NFC communication connection, so that the amplitude of the first frequency can be transmitted to the signal electronics after it has been determined by the smartphone 3. The superordinate control can be arranged either in the smartphone 3 or in the signal electronics of the converter.

The torque ripple determined in this manner can then be determined as a function of the angular position of the rotor shaft and can thus be used permanently later during normal operation of the drive to reduce emissions.

The first frequency can deviate from the speed of the electric motor if the high amplitude is caused by a toothing part whose speed is geared down according to a transmission ratio of the transmission. Nevertheless, the speed of the toothing part is used for the torque ripple.

### List of Reference Numerals

1 Drive, e.g., transmission motor
2 Supporting device having a permanent magnet
3 Smartphone
4 Holding device
30 Holder
31 Threaded bolt

1-10. (canceled).

11. A system, comprising:
a drive including a transmission and an electric motor configured to drive the transmission;
a support device including a permanent magnet; and
a smartphone including:
a vibration sensor;
a data collection device;
a signal transformation device; and
an evaluation unit;
wherein the smartphone is configured to:
supply values recorded by the vibration sensor to the data collection device;
store a temporal profile of the values in the data collection device as a value profile;
transform the value profile using the signal transformation device; and
evaluate the transformed value profile using the evaluation unit and compare the transformed value profile with transformed value profiles previously stored in the smartphone and display, dispatch, and/or send a warning in response to an excessive deviation of the transformed value profile from the stored transformed value profiles.

12. The system according to claim 11, wherein the drive includes a transmission motor fed by a converter, and the vibration sensor includes a structure-borne sound sensor.

13. The system according to claim 11, wherein the evaluation unit includes a neural network configured to compare and perform a learning phase on the stored transformed value profiles fed to the evaluation unit.

14. The system according to claim 11, wherein the signal transformation includes a Laplace transformation and/or a Fourier transformation.

15. The system according to claim 11, wherein the drive includes a ferromagnetic part, the supporting device is magnetically fastened to the ferromagnetic part, the supporting device has a flat surface on a side facing the smartphone, the smartphone being arranged on the flat surface.

16. The system according to claim 15, wherein the ferromagnetic part includes a bearing flange of the transmission.

17. The system according to claim 15, further comprising a holding device configured to prevent the smartphone from slipping parallel to a plane of the flat surface.

18. The system according to claim 17, wherein the holding device includes an elastically deformable band and/or a material that adheres to a housing of the transmission.

19. The system according to claim 17, wherein the holding device includes an elastically deformable band that wraps around the smartphone and the drive and/or a plastic and/or plasticine material that adheres to a housing of the transmission.

20. The system according to claim 15, wherein the supporting device is fastened to the drive by a screw that is screwed into a threaded bore of the drive and is arranged as a holder for the smartphone, the holder being pressed against the ferromagnetic part by the screw.

21. The system according to claim 11, wherein the supporting device is fastened to the drive by a metallic threaded bolt that is connected to a holder in a material-bonding manner and that is screwed into a threaded bore of the drive, and the supporting device is arranged as a holder for the smartphone.

22. The system according to claim 21, wherein the permanent magnet is arranged in the holder and/or is encapsulated with plastic.

23. The system according to claim 11, wherein a converter configured to feed a transmission motor of the drive includes a superordinate control device configured to regulate an amplitude of a first frequency of vibration recorded by the vibration sensor to zero, to set as control variables a phase and an amplitude of a torque ripple that is added to a torque target value to form a target value for torque that is transmitted to a control device configured to control s torque of the electric motor of the drive, the control device adapted to control an actual value of the torque of the electric motor of the drive to the target value for torque.

24. The system according to claim 23, wherein the control device is adapted to control the actual value of the torque of the electric motor of the drive to the target value for torque by adjusting a motor voltage and/or a motor current of the electric motor.

25. The system according to claim 11, wherein the electric motor includes an angle sensor configured to determine an angular position of a rotor of the electric motor, and the drive is configured such that torque ripple determined as a function of the angular position and having an amplitude and a phase at which an amplitude of a first frequency of vibration does not exceed a permissible level is permanently added to a torque target value during normal operation.

26. The system according to claim 25, wherein, in the normal operation, the smartphone is removed from the supporting device.

27. A method for operating the system recited in claim 11, comprising:
storing values recorded by the sensor as a value profile;
after the storing, transforming the value profile; and
after the transforming, checking the value profile by a neural network for exceedance of a permissible degree of deviation.

28. The method according to claim 27, further comprising, before the storing, feeding permissible transformed value profiles to the neural network in a learning phase.

29. The method according to claim 27, further comprising, after the checking, regulating an amplitude of a first frequency of a vibration recorded by the vibration sensor to zero, setting, by a superordinate control device, a phase and an amplitude of a torque ripple, transmitting the phase and the amplitude of the torque ripple to a control device configured to control a torque of the electric motor of the drive, and adding the torque ripple to a torque target value of the control device.

30. The method according to claim 27, further comprising, after the transforming, regulating an amplitude of a first frequency of a vibration recorded by the vibration sensor to zero, setting, by a superordinate control device, a phase and an amplitude of a torque ripple as control variables, adding the torque ripple to a torque target value to form a target value for torque that is transmitted to a control device to control a torque of the electric motor of the drive, the control device controlling an actual value of torque of the electric motor of the drive to the target value for torque.

31. The method according to claim 30, wherein the control device controls the actual value of torque of the electric motor of the drive to the target value for torque by adjusting a motor voltage and/or a motor current of the electric motor.

32. The method according to claim 27, further comprising determining an angular position of a rotor of the electric motor, and using a phase and an amplitude at which a smallest amplitude of a first frequency is reached to determine a torque ripple that has the first frequency as a function of the angular position and which is added to the torque target value.

33. The method according to claim 32, wherein the amplitude of the first frequency of the vibration does not exceed a permissible level.
